(19) United States
(12) Patent Application Publication
(10) Pub. No.: US 2013/0093318 A1
(43) Pub. Date: Apr. 18, 2013

(54) Conductive Layer Net Ignition Aids

(71) Applicant: GENERAL ELECTRIC COMPANY, Schenectady, NY (US)

(72) Inventors: Tamas Panyik, Budapest (HU); Zoltan Janki, Budapest (HU); Titusz Janos Talalt, Budapest (HU); Agoston Boroczki, Budapest (HU); Istvan Janos Jelinek, Budapest (HU); Gabor Toros, Budapest (HU); Raghu Ramaiah, Mentor, OH (US)

(73) Assignee: GENERAL ELECTRIC COMPANY, Schenectady, NY (US)

(21) Appl. No.: 13/706,700

(22) Filed: Dec. 6, 2012

Related U.S. Application Data
(63) Continuation-in-part of application No. 13/178,918, filed on Jul. 8, 2011.
Application No. 13/178,918 is a continuation-in-part of application No. 13/275,908, filed on Oct. 18, 2011.

(51) Int. Cl. H01J 61/04; H01J 61/36

(52) U.S. Cl. CPC H01J 61/04; H01J 61/36
USPC 313/623; 313/631

(57) ABSTRACT

Embodiments of the present invention relate to high intensity discharge (“HID”) lamps which have an electrically insulating arc tube including a central portion with an interior discharge region and two legs each extending from an end of the central portion, the central portion being a larger size than the legs. Electrical conductors extend through each of the legs and are ending in electrode components which are spaced apart from each other in the discharge region. A light transmitting envelope encloses the arc tube, and a frame member is electrically attached to one of the electrical conductors. Pursuant to some embodiments, an ignition aid is provided which includes an electrically conductive element disposed on one of the legs. The ignition aid includes a conductive layer that extends from the electrically conductive element to the central portion.

### RELATED APPLICATIONS

This application relates to, and claims benefit of and priority to, U.S. patent application Ser. Nos. 13/178,918 and 13/275,908 filed on Jul. 8, 2011 and Oct. 18, 2011 respectively, the contents of each of which are hereby incorporated by reference in their entirety herein.

### FIELD

Embodiments relate to high intensity discharge lamps. More particularly, embodiments relate to conductive layer net ignition aids for use in such lamps.

### BACKGROUND

Ceramic metal halide high intensity discharge lamps (referred to herein as “HID lamps”) are a type of electrical gas-discharge lamp which produces light by means of an electric arc between tungsten electrodes housed inside a translucent or transparent fused quartz or fused alumina arc tube. Initially, the gas contained in the arc tube of an HID lamp is non-conductive. If an electric potential is applied on the outside conductors (terminals) attached to electrode parts inside the arc tube, this creates a favorable situation to strip the outer orbital electrons from the atoms of the gas and thus create free electrons, which are then accelerated though the gas by the electric field generated between the electrodes. If the electric field is high enough, initial free electrons thus created will create additional electrons by inelastic collisions with gas atoms and ions leading to ionization of the atoms, and initiates an electron avalanche. Such an avalanche initiates the discharge arc. However, to create such a dielectric breakdown of the gas by the electric field requires several kilovolts of electric potential. Higher and higher electric potentials require more expensive external electrical circuitry, and may not be commercially feasible. Unwanted breakdown can also occur in the outer jacket and in the cap-base region of an HID lamp.

Discharges for commercial applications employ an additional source of free electrons, which removes the need for generating such high voltages to initiate the discharge. Such external sources can be a heated filament, use of the ever present cosmic rays, or providing a source of electrons by radioactive decay. Heated filaments are not practical in HID lamps, and the cosmic ray background radiation is insufficient to dramatically reduce the need for very high electric fields needed to initiate the ignition, unless other methods are used to lower the breakdown voltage.

For providing a source of electrons by radioactive decay, typically what has been used in the past in the HID arc tube is a radioactive gas, such as Kr⁸⁵ with most of the decay products being beta particles (i.e., electrons). Kr⁸⁵ has a half-life of 10.8 years, with 99.6% of the decay products being beta particles (i.e., electrons) having a maximum kinetic energy of 687 keV. These electrons have very high energy, and in many respects are an ideal source for free electrons and used widely as such for these applications. To provide enough of these high energy electrons by radioactive decay, previous HID lamp designs utilized a significant quantity of this gas.

The presence of Kr⁸⁵ in such lamps diminishes the need for providing very high electric potential on the conductors, which makes the external electrical circuitry (a ballast) and systems design simpler and more cost effective. Typical applications use such a radioactive gas with a ballast that provides a high electric pulse for a very short duration, typically in the millisecond (microsecond) range, that is very effective in creating the electron avalanche referred to earlier. However, recent UN2911 government regulations limit the amount of radioactive Kr⁸⁵ used in lamps. These regulations proscribe the HID lamp manufacturers from using the large quantity of Kr⁸⁵gas that has been previously used, as described in preceding paragraph.

A number of ignition aids have been designed for improving the ignition capabilities of high intensity discharge lamps. U.S. Patent application Pub. No. 2002/0185973 discloses a lamp in which wire is wrapped around both end potions usually referred to as “legs” of the arc tube and its central body as both of serving as an ignition aid and a means for containment, but is not connected to the electrodes. Another reference, U.S. Pat. No. 5,541,480, discloses an ignition aid in which a conductor that is coated on an exterior surface of an arc tube of constant diameter between the electrodes is connected to a conductive frame wire that contacts an electrode. U.S. Pat. No. 6,222,320 discloses an ignition aid for a lamp including an arc tube having a central body portion and smaller diameter legs extending from the body portion, wherein a conductor that is in contact with a conductive frame wire that contacts one of the electrodes, contacts only the central body portion of the arc tube.

In our co-pending and commonly-assigned U.S. patent application Ser. Nos. 13/178,918 and 13/275,908 we propose techniques to reduce the amount of radioactive Kr⁸⁵ used in HID lamps while providing desirable performance characteristics. In those applications, we describe the use of ignition aids including electrically conductive foil fastened to a frame member and forming a closed loop that encircles one of the legs of an arc tube around one of the electrical conductors.

### BRIEF DESCRIPTION OF THE DRAWINGS

FIG. 1 is a side elevational view of a single ended HID lamp with a conductive layer net ignition aid pursuant to some embodiments.

FIG. 2 is an axial cross-sectional view of an HID lamp with a conductive layer net ignition aid pursuant to some embodiments.

FIG. 3 is an axial cross-sectional view of an end portion of an arc tube of an HID lamp with a conductive layer net ignition aid pursuant to some embodiments.

FIG. 4 is a side view of a portion of an HID lamp with a conductive layer net ignition aid pursuant to some embodiments.

FIG. 5 is a side view of a portion of an HID lamp with a conductive layer net ignition aid pursuant to some embodiments.

FIG. 6 is a side view of a portion of an HID lamp with a conductive layer net ignition aid pursuant to some embodiments.

FIGS. 7A-7D are side views of a portion of an arc tube of an HID lamp with a contact on an arctube leg for use with a conductive layer net ignition aid pursuant to some embodiments.

FIGS. 8A-8B are side views of a portion of a voidless lamp with a conductive layer net ignition aid pursuant to some embodiments.

FIG. 9 is a perspective view of an end portion of an arc tube of an HID lamp with a plug connection and conductive layer net ignition aid pursuant to some embodiments.

FIGS. 10A-10C are perspective views of a portion of the arc tube of the HID lamp of FIG. 9 with a plug connection formed using a two piece seal pursuant to some embodiments.

FIGS. 11A-11B are perspective views of an end portion of the arc tube of the HID lamp of FIG. 9 with a plug connection formed using a one piece seal pursuant to some embodiments.

FIGS. 12A-12B are perspective views of an end portion of an arc tube of an HID lamp with a plug connection and conductive layer net ignition aid pursuant to some embodiments.

### DETAILED DESCRIPTION

Embodiments of the present invention relate to high intensity discharge (“HID”) lamps which have an electrically insulating arc tube including a central portion with an interior discharge region and two legs each extending from an end of the central portion, the central portion being a larger size than the legs. Electrical conductors extend through each of the legs and are ending in electrode components which are spaced apart from each other in the discharge region. A light transmitting envelope encloses the arc tube, and frame members are electrically attached to the conductors. Pursuant to some embodiments, an ignition aid is provided which includes an electrically conductive element disposed on one of the legs. The ignition aid includes a conductive layer that extends from the electrically conductive element to the central portion.

In some embodiments shown, the electrically conductive element is a metal foil which is wrapped around the leg and which is in electrical contact with the frame member. It is to be noted that the term “metal foil” here is assumed to be the most simplified representation of potentially more complex metallic components ranging from a foil as a flattened wire to a more complex metallic structures, such as a coiled coil wire structure around the leg. In some embodiments, the electrically conductive element is a metal tube (such as a flexible metal tube, or a pinched metal tube) electrically connecting to the conductive layer and to the electrical conductor extending through the leg. In some embodiments, where the lamp 10 is a legless (usually also called as “voidless”) CMH lamp, the conductive element may be a conductive ceramic cermet sealing the arc tube ends in a vacuum-tight manner. In some embodiments, the conductive element is a seal ring sealing the arc tube at the end portion of the leg.

Embodiments allow HID lamps to be efficiently operated with little or no Kr⁸⁵ radioactive material needed to achieve reliable cold starting and hot restart of lamps. A number of different desirable performance characteristics may be achieved through different configurations of the conductive element and conductive layer combination of the present invention, including configurations which produce improved cold starting of HID lamps, configurations producing improved hot re-striking and re-starting, and configurations achieving desirable performance in both cold start and hot re-strike and re-start conditions. Pursuant to some embodiments, the conductive layer may be formed in several segments, including a first segment that is formed under the electrically conductive element on a leg of the lamp (e.g., such as under a foil ring on a leg of the lamp), a second segment that is located on the curved or tapered part of a plug side of the arc tube, a third segment that is located on the plug side extending to the cylindrical or barrel-shaped surface of the center portion of the tube, and a fourth segment that is disposed along a surface of the center portion of the tube. The fourth segment may be formed in different shapes or configurations to achieve differing results as will be described further herein. The result is an improved ignition aid for use with ceramic metal halide HID lamps.

To provide an overall understanding of the invention, certain illustrative embodiments will now be described, including various configurations of high intensity discharge (HID) lamps having a conductive ignition aid pursuant to the present invention. However, it will be understood by one of ordinary skill in the art that the devices and configurations described herein may be adapted and modified as is appropriate to achieve different operating results and performance and that the devices and configurations described herein may be employed in other designs and configurations, and that such other additions and modifications will not depart from the scope thereof.

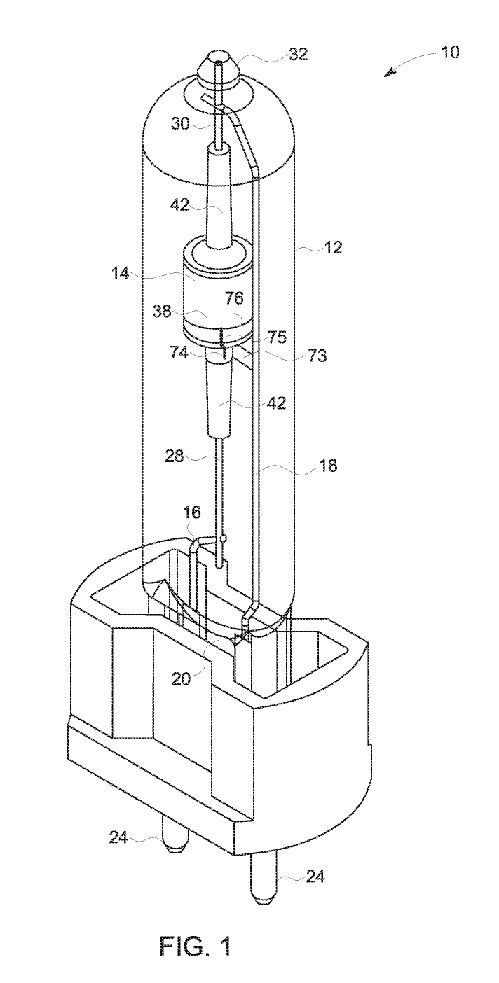

Features of some embodiments will first be described by reference to FIG. 1, where a ceramic metal halide HID lamp 10 includes an outer shroud or bulb 12 (hereinafter “bulb 12”) enclosing an arc tube 14. The particular configuration of the HID lamp 10 shown in FIG. 1 is a single ended lamp, or a lamp having electrical contacts 24 on only one end of the lamp 10. Those skilled in the art, upon reading the following disclosure, will appreciate that features of the present invention may also be desirably used other lamp configurations.

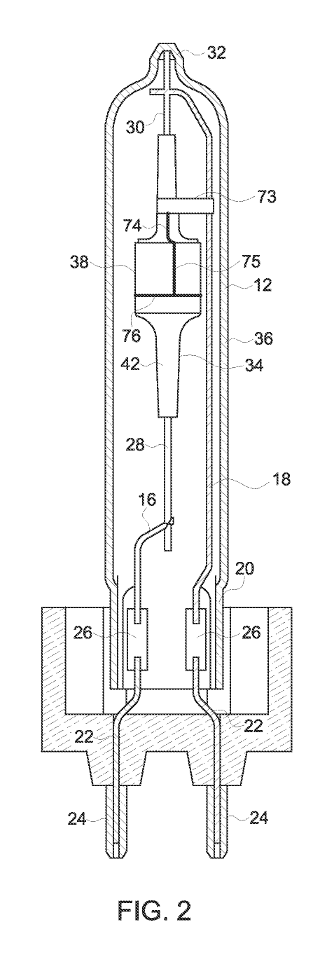

Electrically conductive frame members or wires 16, 18 are partially embedded in a glass pinch portion 20 at one end of the bulb 12. Leads (not shown in FIG. 1, but depicted as item 22 in FIG. 2) extend from contact pins 24 external to the bulb 12. The leads are electrically connected to the frame wires 16, 18 by electrically conductive foil (not shown in FIG. 1, but depicted as item 26 in FIG. 2) located in the pinch portion 20. Each foil 26 is welded or otherwise attached to one of the legs 42 via one of the frame wires 16, 18. Electrically conductive feedthroughs 28, 30 extend into each end of the arc tube 14. The lower feedthrough 28 is welded or otherwise coupled to the short frame member 16 while the upper feedthrough 30 is welded to the long frame member 18. The upper feedthrough 30 extends upwardly past the connection with the long frame member 18 and is retained in place by being in contact with a portion 32 of glass of the outer bulb that has been partially melted around the feedthrough 30 during manufacturing. The long frame member 18 extends along the length of the arc tube 14 but is spaced apart from a side 34 of the arc tube 14 near a side wall 36 of the bulb 12. The frame members 16, 18 are formed of rigid wire and support the arc tube 14 inside the bulb 12 preventing its movement.

The arc tube 14 includes a central barrel shaped portion 38 with an interior discharge region and two legs 42 each extending from an end of the central portion 38. The central portion 38 is a larger size (e.g., diameter) than the legs 42. Electrical conductors extend through each of the legs, and are attached to electrode parts inside the arc tube which are spaced apart from each other in the discharge region. A light transmitting envelope encloses the arc tube 14. A frame member 16, 18 is electrically attached to one of the electrical conductors. Pursuant to embodiments of the present invention, an ignition aid comprises an electrically conductive element, for example, a conductive foil 73, and a conductive layer formed from several segments or portions 74, 75, 76 (as well as a segment not shown in FIG. 1). The different segments provide an electrical connection between the conductive foil 73 and a portion of the conductive layer disposed on a surface of the central portion 38. Pursuant to some embodiments, such as that shown in FIG. 1, the foil 73 is disposed around one of the legs 42. For clarity and convenience, each of the legs 42 of the various embodiments depicted herein are referenced using a common reference number (“42”) however, those skilled in the art, upon reading this disclosure, will appreciate that the legs of different lamp designs may have different configurations, and may terminate in, or be formed of, different types of plug designs which will be apparent upon viewing the various figures herein and to those of skill in the art.

In general, HID lamps such as the lamp 10 require a relatively high voltage to perform a cold start ignition, typically from between 3-5 kV. HID lamps 10 that are aided by the use of radioactive Kr⁸⁵ gas may have a lower voltage required to perform a cold start (e.g., between 1-2 kV). Applicants have found that HID lamps using a conductive layer net ignition aid pursuant to the present invention achieve similar cold restart voltage requirements (e.g., between 1-2 kV), thereby allowing HID lamps to be deployed with less (or no) radioactive gas. Further, HID lamps require an even higher voltage to reliably perform a hot re-strike (e.g., between 15-20 kV). Applicants have found that HID lamps using a conductive layer net ignition aid pursuant to the present invention require a lower voltage (between 9-12 kV) to perform a hot re-strike. As a result, embodiments allow desirable performance characteristics with no (or little) Kr⁸⁵ gas. In embodiments where no Kr⁸⁵ gas is used (that is, there is no radioactive material in the discharge space), ignition of the lamp 10 requires a higher electric field (“E-field”) to accelerate the low amount of electrons. A higher E-field could be achieved by increasing the potential difference between the electrodes; however, embodiments of the present invention reduce the E-field required by effectively adding an extra electrode located (with the combination of the conductive foil 73 and the conductive layer). The result is improved cold start, hot re-strike and hot re-start performance of HID lamps 10.

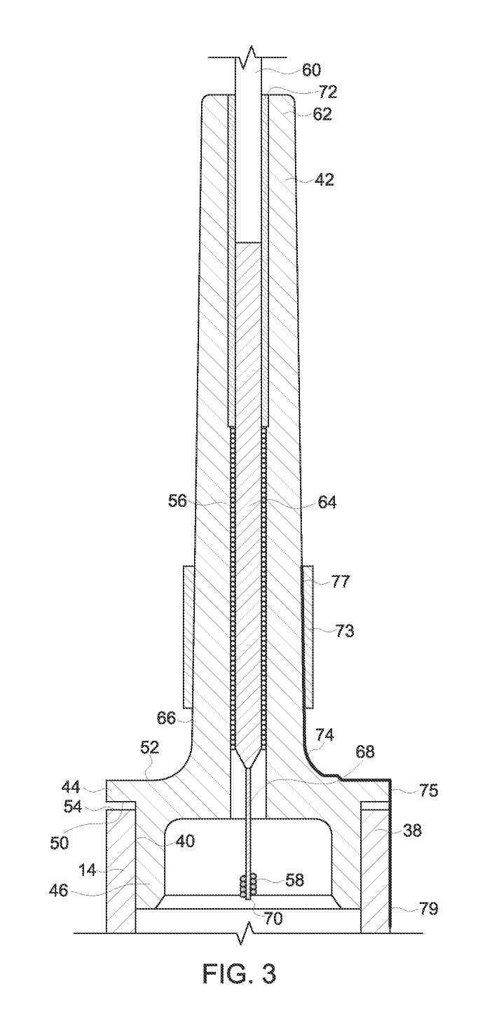

A number of different configurations of conductive layer net ignition aids have been found to provide desirable performance and operational results and several different configurations will be described herein. In the embodiment depicted in FIG. 1, the conductive foil 73 is wrapped around the arc tube leg 42 on the same side of the arc tube 14 as the electrode that is powered (the electrode extends within an inner portion of the arc tube 14 and is not shown on FIG. 1, but is shown as coupled to contact 24 via a feedthrough 28 and an electrically conductive frame member 16). In other embodiments (including several described below in conjunction with FIG. 3), the foil 73 may be wrapped around the arc tube leg 42 on the side of the arc tube as an electrode that is grounded. The foil 73 is configured to operate as a capacitively coupled electrode, and may be wrapped around the leg as described in our co-pending and commonly assigned U.S. patent application Ser. Nos. 13/178,918 and 13/275,908. In some embodiments, the foil 73 is wrapped completely around the leg 42 in order to have a complete circle (from a sectional view) of electrically conductive foil. This maximizes the capacitive effect of the foil and helps to maximize the E-field. The E-field is further maximized through use of the conductive layer electrically coupled to the conductive foil 73. The conductive foil 73 may be comprised of a base metal selected from the group consisting of Nb, Mo, Ta, Pt, Re, W, Ni, combinations thereof or a combination of any of the above base metals with cladding composed of one or more of the base metals. The cladding can improve weldability of the foil. A thickness of the foil can range from 0.05 to 0.2 mm, and in particular from 0.05-0.15 mm.

The conductive layer (consisting of several segments or portions) is provided to connect the opposite electrode potential to the conductive foil 73, and extends from the foil 73 to the central portion 38 of the arc tube 14. The conductive layer may be formed of a conductive material easily disposed on the device during a manufacturing process (e.g., the material may be painted on the relevant surfaces of the device). The conductive layer may, in some embodiments, include a first segment which is disposed on the surface of the leg 42 beneath the location of the conductive foil 73 before the foil 73 is installed, providing an electrical connection between the conductive foil 73 and the conductive layer. The foil 73 can be electrically attached to the frame member 18, by welding for example, at only one end of the foil, the other end of the foil being unattached. Alternatively, the foil 73 can be electrically attached to the frame member 18 at one end, for example by welding, and can be electrically attached to itself at the other end (e.g., by welding) after a central part of the foil between the ends is wrapped around the leg. Instead of welding, the foil 73 may be attached to the frame member and to itself such as by crimping or other manner known in the art like brazing.

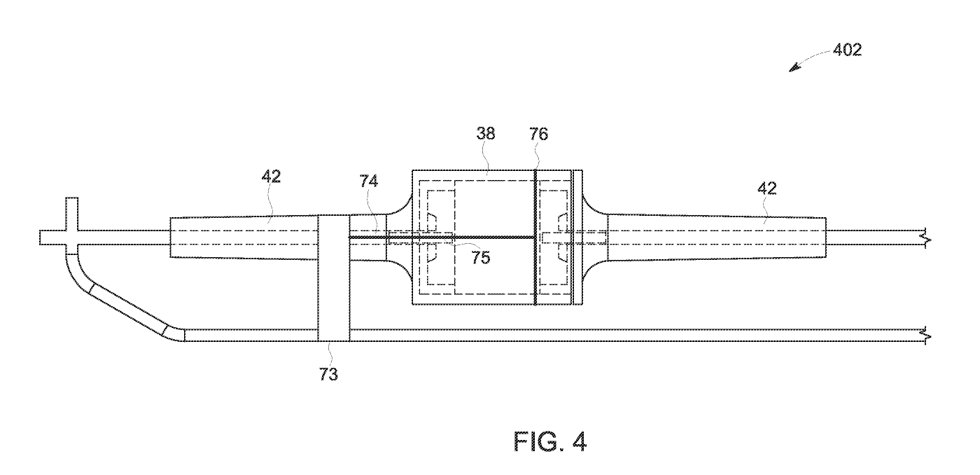

A second segment of the conductive layer extends from the first segment to a curved or tapered portion of the plug side of the arc tube 14 (shown in more detail in FIGS. 3 and 4). In some embodiments, the second segment may include one or more paths that extend from the first segment. For example, as shown in FIG. 1, a single line of conductive material is shown; however, multiple lines may extend from the conductive foil 73 to the central portion 38. A third segment of conductive layer extends from the second segment to a selected point on the surface of the central portion 38. The position of the selected point is, in some embodiments, based on a desired performance characteristic of the ignition aid. For example, in some embodiments, the selected point is chosen to place the end of the third segment an axial distance of approximately between 0 mm and 3 mm from a tip of the powered electrode inside the arc tube. In some embodiments, a fourth segment is provided which extends from the third segment around a circumference of the central portion 38.

Referring now to FIG. 2, a further embodiment of a lamp 10 is shown in which the conductive foil 73 is shown as attached to frame member 18, and the conductive layer net ignition aid (shown as segments 74, 75, 76) extends from the top of the central portion 38 of the arc tube 14 toward a bottom end of the arc tube 14 (to place segment 76 proximate a tip of an electrode placed at an opposite potential). For convenience herein, such an embodiment will be referred to as a “front ring” embodiment of the conductive layer net ignition aid of the present invention, while embodiments such as shown in FIG. 1 will be referred to as a “back ring” embodiment of the present invention. Pursuant to some embodiments, the configuration depicted in FIG. 2 may also be modified such that the conductive layer does not include segment 76—instead, improved ignition characteristics are provided by simply extending segment 75 to a point on a surface of the central portion 38. Such an embodiment will be referred to herein as a “line” embodiment of the present invention.

Referring to FIG. 3, features of portions of the arc tube 14 are shown. The arc tube 14 includes a tubular central barrel shaped portion 38 of constant diameter and openings 40 at either end of the barrel portion. Two legs or capillaries 42 extend from the central portion 38. The arc tube body and legs can be formed of light transmitting ceramic material such as polycrystalline alumina. Each of the legs 42 can include a flange 44 and a boss 46 extending from the flange into the opening 40 of the central portion into an interior discharge region 48 of the barrel portion 38. Throughout this disclosure, various shapes and configurations of a discharge area within an HID lamp are shown (in FIG. 3, the discharge chamber is shown as the area at the bottom of the figure, into which the electrodes 58 extend). Those skilled in the art, upon reading this disclosure, will appreciate that embodiments may be used with desirable results in conjunction with a variety of different geometries and configurations, including shaped arc tubes (with elliptical or other arc chamber geometries). The legs each include inner flange surface 50 and outer flange surface 52, the inner flange surface 50 abutting a side face 54 of the cylindrical barrel portion 38. The legs 42 include passages 56 along their length. The conductive feedthroughs (items 28, 30 of FIGS. 1 and 2) extend into the passages 56 and are electrically connected to electrodes 58 that are spaced apart from each other in the discharge region. The feedthroughs 28, 30 are electrically conductive. In one example, there is a niobium feedthrough portion 60 that extends from outside the leg into the distal portion 62 of the leg remote from the central portion 38. The niobium feedthrough portion 60 is electrically connected to a molybdenum feedthrough portion 64, which can include a central wire with material coiled around it. At proximal leg portion 66 near the central portion 38 and connected to the molybdenum feedthrough is a tungsten portion 68 of the electrode 58 also including conductive material coiled around it and having a tip 70. The coils around the feedthrough portion 64 and around the tungsten portion 68 are the same material as the wire they wrap around.

A conductive foil 73 is shown as wrapped around the leg 42, with a first segment 77 of a conductive layer disposed between the foil 73 and a surface of the leg 42. The conductive layer continues with a second segment 74 traversing an area between the conductive foil 73 and curved surface of the outer flange 52, and further continues with a third segment 75 extending to a point 79 on an outer surface of the tubular central barrel 38. The point 79 is located such that it is near the tip 70 of the electrode 58 (e.g., between approximately 0 mm and 3 mm apart in arc tube axial direction). A fourth segment (not shown in FIG. 3) of the conductive layer is disposed around an outer surface of the tubular central barrel (at point 79). Those skilled in the art, upon reading this disclosure, will appreciate that various differences in the feedthrough and electrode design and composition can be made without departing from the scope of this disclosure. A seal glass frit 72 is used inside the passages 56 of the legs 42 around the niobium and molybdenum feedthrough portions to hermetically seal the arc tube after ionizable material has been charged into it. The conductive foil 73 is disposed around the leg 42 generally at a location of the molybdenum feedthrough.

Electrical current supplied to the contacts reaches the electrodes via the frame members and feedthroughs, and generates an arc between the electrodes. One electrode (e.g., the electrode connected to feedthrough 28 in FIG. 2) is provided an AC operating voltage by the ballast while the other electrode is at the opposite potential. The electrode connected to feedthrough 30 in FIG. 2 can also be grounded. Ignition voltage pulses and rms operating voltage are provided to the lamp via the ballast. It should be appreciated that the one electrode referred to above can be the opposite as what is shown and described regarding FIG. 2. For example, the electrode connected to feedthrough 30 can receive the full applied voltage from the ballast while the electrode connected to feedthrough 28 is grounded. Alternatively, the applied voltage to the lamp can be a floating voltage, i.e., each electrode can have voltage applied to it in AC cycle (equal, but opposite).

The conductive foil 73 and conductive layer net ignition aid is used to improve ignition of the lamp 10. The ignition aid includes the electrically conductive foil 73 that is fastened to the frame member 18 and encircles a leg 42 of the arc tube 14 around a feedthrough 30 extending in that leg. The foil 73 is spaced apart and electrically insulated from the feedthrough 30 which is encircled by the electrically insulating ceramic material of the arc tube leg. While not wanting to be bound by theory it is believed that the foil 73 attached to conductive layers 74, 75, 76 and feedthrough 30 in the arc tube leg (and/or electrode in the arc tube central portion), along with the nonconductive ceramic wall of the leg and fill gas in the arc tube leg, function as a capacitor. Typically, there is no additional electrical conductor encircling the arc tube leg opposite the ignition aid or the central portion of the arc tube, like it is illustrated in the drawings.

The reason why the conductive foil 73 and conductive layer 74, 75, 76 are a further enhancement of the lamp starting phenomenon is described below. For purposes of explanation, a conventional discharge lamp does not have the conductive layer net ignition aid, but contains Kr85 gas and Ar gas. A ballast is used to apply the high voltage transient ignition pulse between the electrodes contained in the hermetically sealed discharge region of the arc tube. The concentration of Kr85 gas used in conventional lamps exceeds governmental limitations below which there are no special labeling or transportation requirements. The electric field generated in the conventional discharge lamp is defined as the applied voltage on the opposing electrical conductors divided by the gap between the electrodes inside the arc tube. The larger the gap between the electrodes, the lower the electric field. The lower the electric field, the harder it is to reliably initiate the discharge, even though Kr85 gas and the high voltage electric pulse that is provided by the ballast, are present. Referring to the embodiment shown in FIG. 2, including the foil 73 and conductive layer starting aid of this disclosure as shown, the electric field in the lamp is much higher, by virtue of the fact that the gap is now between, for example, the foil/conductive layer and the adjacent electrode is much smaller. This gap is being much smaller than the gap between the electrodes and hence the electric field is being much larger, the creation of the electron avalanche becomes much easier. Essentially, the upper electrode has been replaced by the foil and conductive layer, as the foil and conductive layer are electrically connected to the upper electrode.

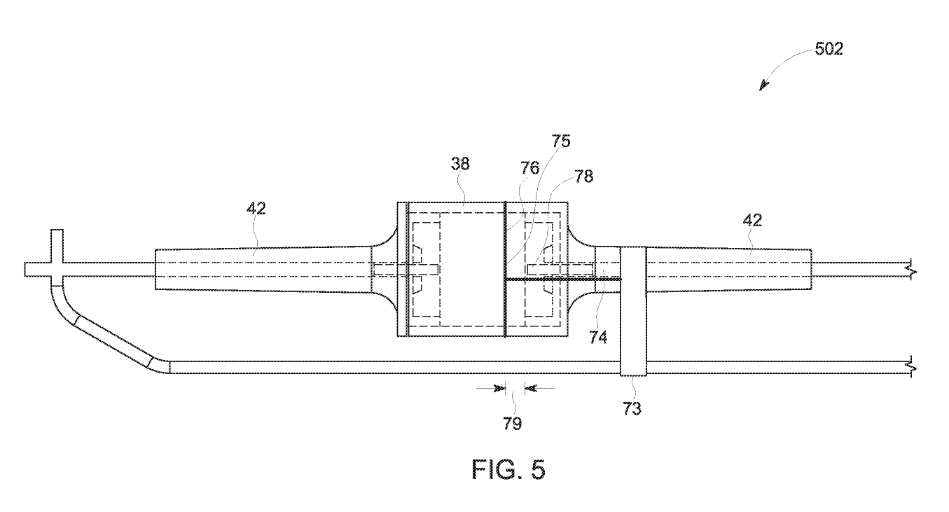

As discussed above, embodiments may include lamps configured as a “line” embodiment, as a “back ring” embodiment, or as a “front ring” embodiment. Each configuration may be used with different arc tube 14 designs. For example, in FIGS. 1 and 2, two piece ceramic arc tubes are shown. Embodiments may also be used in conjunction with one piece arc tubes. For example, referring now to FIG. 4, a variety of embodiments are shown in conjunction with one and two piece arc tubes 14. More particularly, FIG. 4 depicts arc tubes 14 with the conductive layer net ignition aid configured in the “front ring” embodiment, while FIG. 5 depicts arc tubes 14 with the conductive net ignition aid configured in the “back ring” embodiment.

Referring first to FIG. 4, a two piece arc tube 402 is shown with conductive foil 73 on negative potential of the frame coupled to a leg 42 in a “front ring” configuration where the conductive layer net ignition segments extend across a surface of the central portion 38 to a point which is near the location of an electrode coupled to the positive potential. The conductive layer net ignition segments include a fourth segment 76 which encircles the central portion 38, a third segment 75 which extends across a portion of the central portion 38, and a second segment 74 which couples the foil 73 to the second segment. A first segment (not shown in FIG. 4) is underneath the foil 73 providing an electrical connection with the foil 73 to the other segments. The two piece arc tube 402 includes a plug on the side proximate the foil 73. Similar “front ring” configurations may be utilized with desirable results in lamps having an elliptical or spherical (spheroidal) geometry or on bulb-shaped arc tubes as described further below.

Referring now to FIG. 5, a two piece arc tube 502 is shown with conductive foil 73 coupled to a leg 42 in a “back ring” configuration where the conductive layer net ignition segments extend across a surface of the central portion 38 to a point which is near the location of an electrode coupled to the positive potential. The foil 73 is connected to the ground frame and the conductive layer spans only a short portion of the longitudinal surface of the central portion 38 to position the fourth segment of the conductive layer proximate the near electrode. The conductive layer net ignition segments include a fourth segment 76 which encircles the central portion 38, a third segment 75 which extends across a portion of the central portion 38, and a second segment 74 which couples the foil 73 to the second segment. A first segment (not shown in FIG. 5) is underneath the foil 73 providing an electrical connection with the foil 73 to the other segments. The two piece arc tube 402 includes a plug on the side proximate the foil 73.

Also shown in FIG. 5 is a tip of the electrode 78 (contained within a chamber of the central portion 38) and a relative spacing 79 of segment 76 from a tip of the electrode 78. In some embodiments, desirable results are achieved when the spacing 79 is relatively small (e.g., such as between 0 mm and 3 mm). Similar “back ring” configurations may be utilized with desirable results in lamps having an elliptical or spherical (spheroidal) geometry or on bulb-shaped arc tubes as described further below.

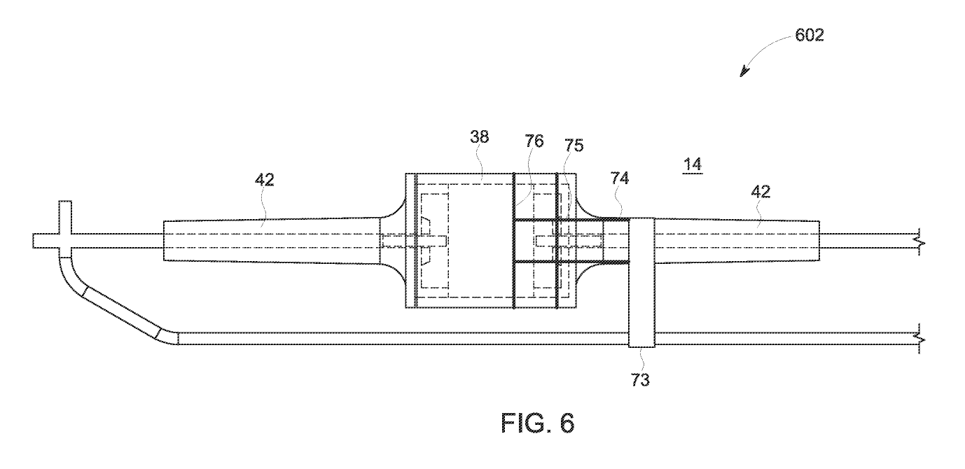

Embodiments may be deployed with different conductive layer configurations. For example, multiple ones of the different segments may be used as shown in FIG. 6. In FIG. 6, a two piece arc tube 602 is shown configured in the “back ring” configuration. As depicted, more than one of the second and third segments 74, 75 are provided (e.g. it is believed a symmetrical set of segments is desirable, such as three or four evenly spaced segments 74, 75). Further, more than one fourth segment 76 may also be provided. Those skilled in the art will appreciate that combinations of multiple segments may also be used (for example, there may be multiple second and third segments 74, 75, but only one fourth segment 76 or vice versa).

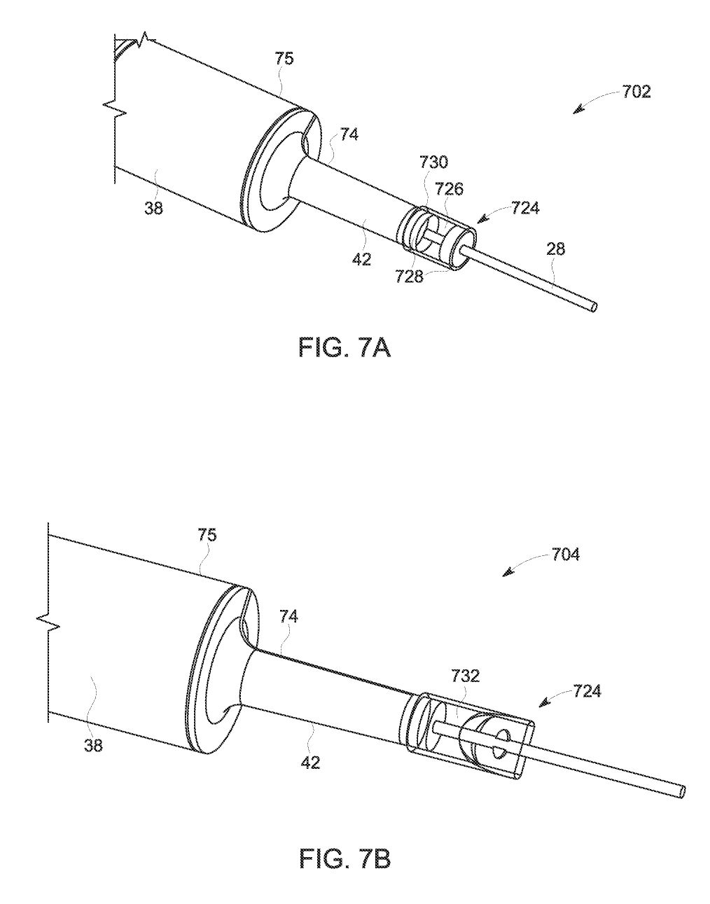

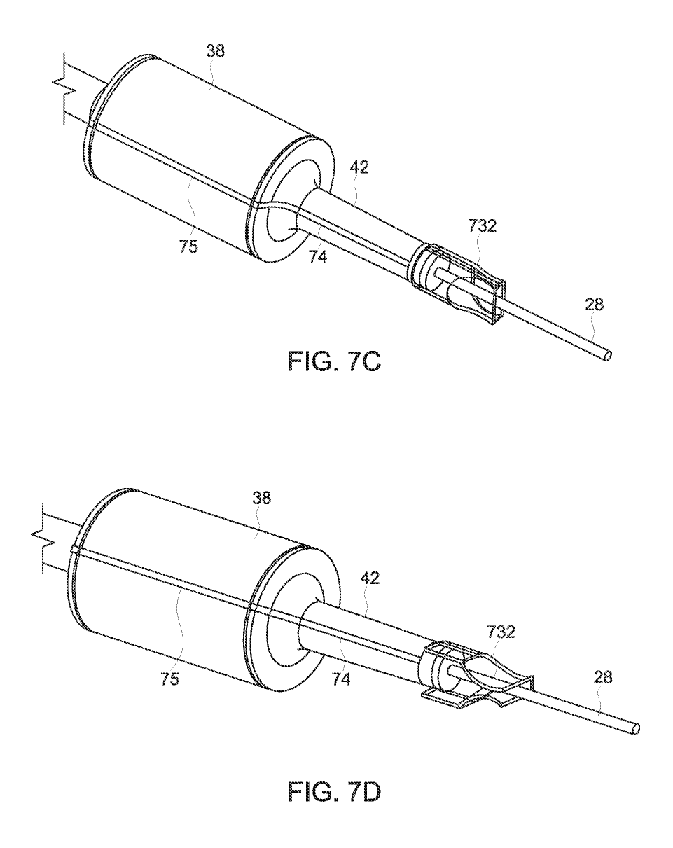

While the use of a conductive foil 73 as the electrically conductive element used to provide an electrical connection with the conductive layer has been described, embodiments may also be used with other electrically conductive elements to form an electrical connection with the conductive layer. For example, referring first to FIG. 7A, one embodiment of a conductive layer net ignition aid for use with a lamp 702 is shown. A portion of a lamp 702 is shown, including a central body portion 38 of an arc tube and a leg 42 with a conductive feedthrough 28 extending therethrough. A conductive layer is shown as including a segment 74 extending along the leg 42 to the central body portion 38 to a segment 75. Those skilled in the art, upon reading this disclosure, will appreciate that additional conductive segments may be provided (e.g., similar to the configurations shown in FIGS. 1-6, above). In the embodiment depicted, the conductive feedthrough 28 is a cathode. In order to electrically couple the conductive layer 74, 75 to the conductive feedthrough 28, an electrical contact structure 724 is provided. In the embodiment depicted in FIG. 7A, the electrical contact structure 724 includes a metal tube 726 surrounding one or more conductive rings 728 as well as non-conductive spacers 730. The electrical contact structure 724 is configured to provide an electrical connection between the feedthrough 28 (in this case, the cathode of the lamp 10) with the conductive layer 74, 75. In some embodiments, the metal tube 726 may be somewhat flexible, allowing for easier manufacturing and assembly of the lamp 10 while ensuring a good electrical connection. In other embodiments, rather than a flexible metal tube 726, a pinched metal tube 732 may be used (as shown in FIG. 7B, 7C and 7D). Further, the metal tube 726, 732 may be a portion of a cylindrical tube (e.g., such as a half section of a cylinder or the like) or some other shaped metallic section. In either configuration, the objective is to provide a good electrical connection between the conductive feedthrough and the conductive layer so that the E-field maximum value at the tip and its surrounding of the powered electrode is increased, and a localized capacitive discharge is first initiated, which then supports evolution of the main discharge between the two opposing electrodes.

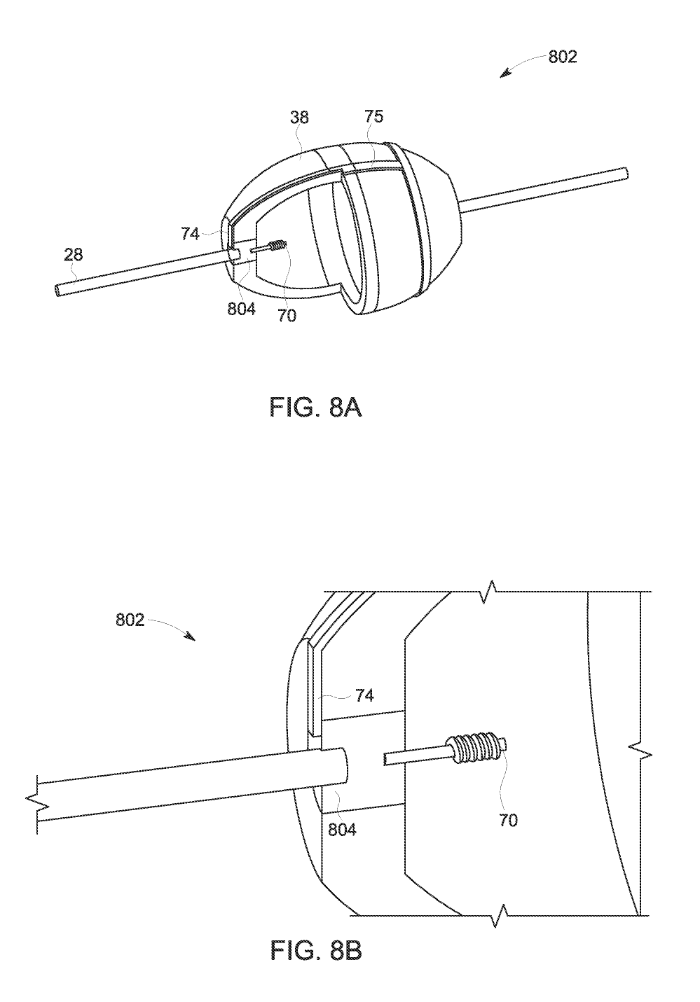

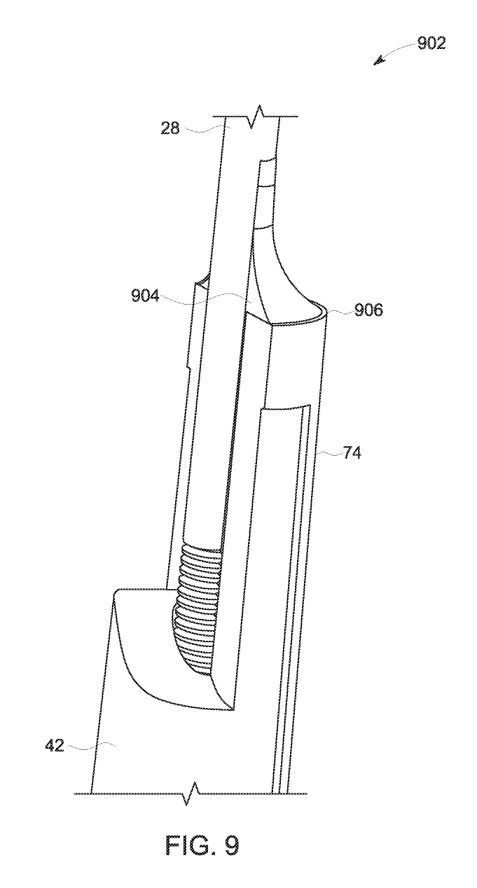

Referring now to FIG. 8, a further embodiment is shown in which the electrically conductive element is a conductive ceramic plug 804. In the embodiment shown in FIG. 8A, an ignition aid for a voidless CMH lamp 802 is shown. Such a voidless lamp design does not utilize ceramic legs (unlike the embodiments depicted in FIGS. 1-7, above), and, as such, the use of a conductive foil (as described above in conjunction with FIGS. 1-6) or a metal tube (as described in conjunction with FIG. 7) is not possible. In order to put the conductive layer 74, 75 in electrical connection with the electrode 70, embodiments utilize a conductive ceramic plug 804 formed in a body of the arc tube 38. The result is an ability to increase the E-field maximum at the tip and its surrounding of the powered electrode 70 and generally within the arc tube 38.

The voidless CMH lamp 802 includes a conductive layer 74, 75 which is electrically connected to an electrode 70 through use of a conductive ceramic plug 804. The conductive layer 74, 75 is on the same electric potential as the electrode 70 through use of the conductive ceramic plug 804. The conductive layer 74, 75 may be shaped or formed to increase the electric field within the lamp as described above in conjunction with the other embodiments disclosed herein. Since no substantial current flows on the electrode 70 or the conductive layer 74, 75, the specific resistance of the conductive aid structure should only be “relatively low” (as is the radial resistance of the conductive ceramic plug). Further details of the voidless CMH lamp 802 are shown in FIG. 8B, depicting the overlap of the conductive layer 74 with the conductive ceramic plug 804 to provide a stable electrical connection between the electrode 70 and the conductive layer 74.

Reference is now made to FIG. 9, where a further embodiment of an electrically conductive element is shown that may be used in conjunction with the conductive layer net ignition aid of the present invention. As shown in FIG. 9, a portion of a leg 42 of an arc tube in an HID lamp is shown (where an electrode assembly 28 is disposed within an inner portion of the leg 42). The electrically conductive element is shown as item 904, 906 in which item 904 is a sealing material and item 906 is an electrically conductive sealing material, the main role of which is to hermetically seal the arc tube. In addition to this main role, the conductive sealing material 906 also provides an electrical connection between the electrode 28 and a segment of a conductive layer 74 (which extends to other segments, such as those disposed on a surface of a central portion of an arc tube as described in the various embodiments discussed above). Pursuant to some embodiments, the electrically conductive element 904, 906 provides an electric connection between the conductive lamp electrode assembly 28 and a segment of a conductive layer 74 without need for an extra element (such as the foil described above) to connect the conductive layer 74 to the frame.

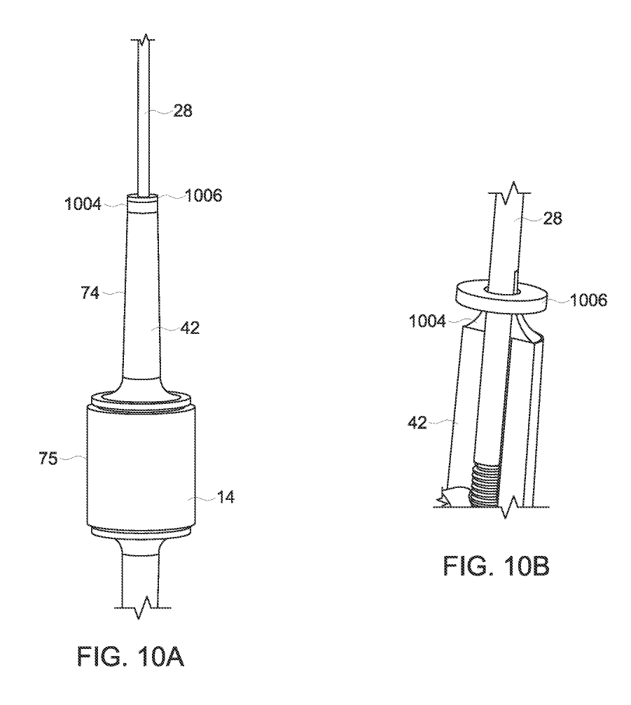

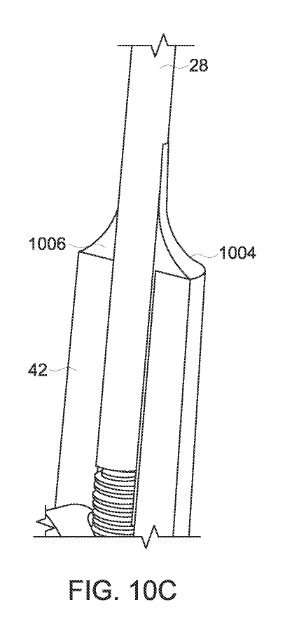

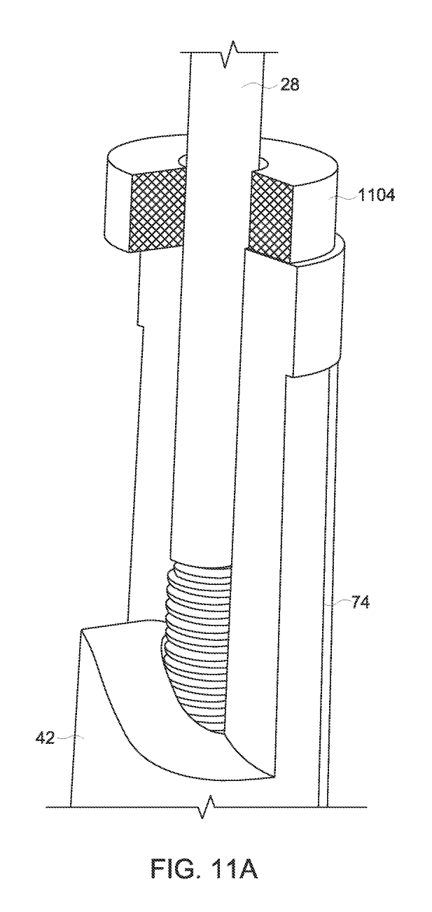

The electrically conductive element 904, 906 may be formed in a number of different ways. For example, referring to FIGS. 10A-10C, the electrically conductive element 904, 906 may be formed from two seal rings, one made of conductive sealing material (shown as item 1006) and one made of standard, non-conductive, sealing material (shown as item 1004). The embodiment shown in FIG. 10A is prior to a heating or manufacture process occurs to melt the seal rings 1004, 1006. In general, the seal rings are selected to have a diameter that approximately matches the diameter of the leg 42. Referring to FIG. 10B, an intermediate product is shown in which the ring of the standard sealing material (item 1006) has been melted by applying heat to the ring area. The non-conductive material, as shown, may provide a non-conductive seal around an area where the electrode assembly 28 enters the leg 42, as well as along a portion of the electrode assembly 28 within the leg 42. Referring to FIG. 10C, a final product is shown in which the ring of the conductive sealing material (item 1004) has also been melted by applying heat to the ring area. The conductive sealing material 1004 forms a conductive connection between the electrode assembly 28 and (not shown in FIG. 10C, but shown in FIG. 9) a segment of a conductive layer 74 disposed along a length of the leg 42. In some embodiments, the two step melting process may be merged into a single step, where both the conductive sealing material 1004 and the non-conductive sealing material 1006 are melted at the same time. The result is an electrically conductive element that provides an electrical connection between the electrode assembly 28 and a segment of a conductive layer, without need for an extra element (such as the foil described above) to connect the conductive layer to the frame.

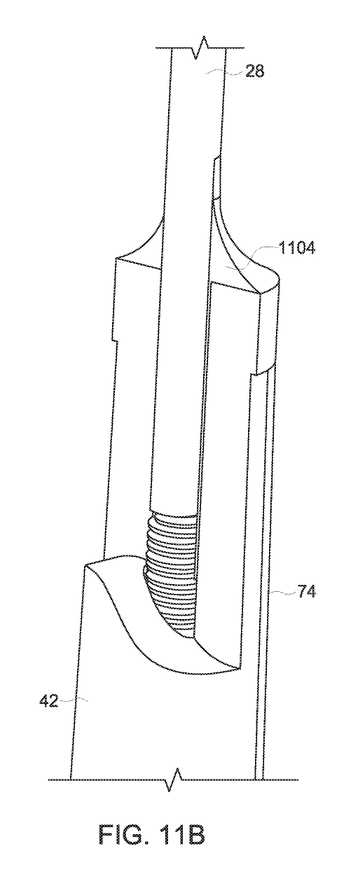

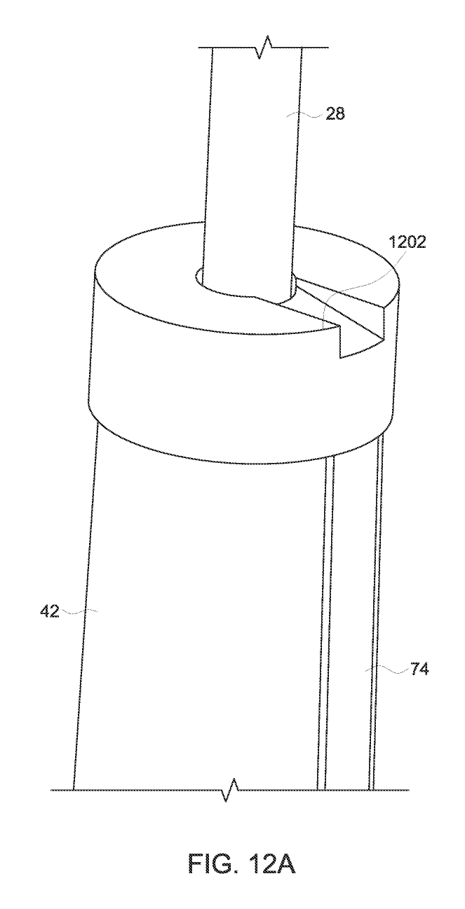

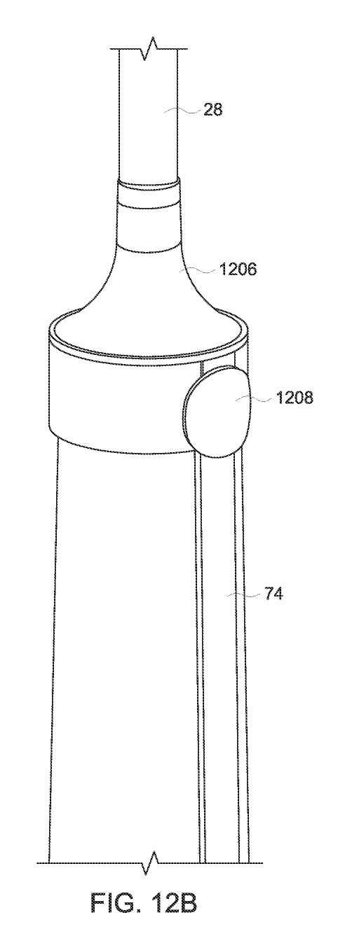

A similar electrically conductive element may be formed using a single seal ring formed of electrically conductive sealing material. For example, as shown in FIG. 11A, a conductive seal ring 1104 may be positioned at the junction of the leg 42 and the electrode assembly 28. The conductive seal ring 1104 is heated to melt the ring to provide a structure as shown in FIG. 11B in which a ring of electrically conductive sealing material 1104 surrounds the electrode assembly 28 as it enters the leg 42. The electrically conductive sealing material 1104 also forms an electrical connection between the electrode 28 and a segment of a conductive layer 74 (which extends, for example, onto a central portion of the arc tube as described elsewhere herein). Pursuant to some embodiments, modifications to leg 42 may be made to provide an improved electrical connection through the use of the conductive sealing material. For example, referring to FIG. 12A, a shaped leg 42 may be provided, where the leg 42 of the arc tube may be formed or machined to have a tapered shoulder portion 1202. When the conductive sealing ring is melted, the tapered shoulder portion 1202 acts as a flow director to enhance the sealing material shape. As shown in FIG. 12B, melting the conductive sealing material 1206 results in a tab portion 1208 which provides an improved electrical connection with the segment of the conductive layer 74.

Lamps using features of embodiments of the present invention have shown desirable performance characteristics in testing. For example, in testing, a lamp having a conductive layer net ignition aid (such as shown in FIG. 1), created a higher Eₘₐₓ than a lamp without an ignition aid, and a higher Eₘₐₓ than lamps using only metal foil ignition aids (as well as higher than lamps using a metal foil ignition aid in conjunction with a “crown” shaped metallic component as an E-field enhancer). By using the conductive net ignition crown aid ignition aid configurations the lamp can be started more reliably using the same open circuit ignitor pulse. Reference is now made to Table 1, where simulated Eₘₐₓ values for certain designs are shown.

TABLE 1

| DESIGN | NOTES | AID TYPE | Eₘₐₓ * 10⁵ [V/m] |
|---|---|---|---|
| No Aid | Arc tube with | None | 6.9 |
| | no ignition | | |
| | aid | | |
| Foil | Foil with no | Foil on leg | 9.94 |
| | conductive | | |
| | layer | | |
| Foil with | Embodiment | Conductive ring | 18.6 |
| conductive | of FIGs. 1-6 | shaped layer on arc | |
| layer | | tube around electrode | |
| | | area | |
| Pinched | Embodiment | Conductive layer aid | 17.6 |
| metal tube | of FIG. 7C. | runs along center arc | |
| on leg with | | tube portion, ring | |
| conductive | | shaped layer around | |
| layer | | opposite electrode | |
| | | area | |

For convenience and ease of exposition, certain relative terms have been used in describing the figures herein. For example, terms such as upper, lower, top, bottom, right, left and the like are relative terms that will change with the orientation of the lamp. These terms are used for improving understanding in this disclosure and should not be used to limit the invention as defined in the claims. Many modifications and variations of the invention will be apparent to those of ordinary skill in the art in light of the foregoing disclosure. Therefore, it is to be understood that, within the scope of the appended claims, the invention can be practiced otherwise than has been specifically shown and described. For example, while certain embodiments have been described which relate to electrically conductive layer net ignition aids used with plug type (cylindrically shaped) arc tubes, those descriptions are for illustrative, but not limiting, purposes only. Features of embodiments may be used with desirable results with a wide variety of different arc tubes and lamp designs.

What is claimed is:

1. A high intensity discharge lamp comprising:
an electrically insulating arc tube including a central portion with an interior discharge region and two legs each extending from an end of said central portion, said central portion being a larger diameter than said legs;
electrical conductors extending through each of said legs and spaced apart from each other in said discharge region;
a light transmitting envelope enclosing said arc tube;
an ignition aid comprising an electrically conductive element disposed on one of said legs and a conductive layer extending from said electrically conductive element to said central portion.

2. The high intensity discharge lamp of claim 1, further comprising:
a frame member electrically attached to one of said electrical conductors;

3. The high intensity discharge lamp of claim 2, wherein the electrically conductive element is a foil, the foil in electrical contact with said frame member and wrapped around said one of said legs.

4. The high intensity discharge lamp of claim 1 , wherein the electrically conductive element is a metallic structure including at least one of (i) a coiled coil wire structure and (ii) a strip of a metallic mesh.

5. The high intensity discharge lamp of claim 1, wherein the electrically conductive element is a metal tube on said leg, said metal tube electrically connecting one of said electrical conductors to said conductive layer.

6. The high intensity discharge lamp of claim 5, wherein the metal tube is a pinched metal tube, wherein a pinched portion of said pinched metal tube is in electrical contact with said one of said electrical conductors.

7. The high intensity discharge lamp of claim 5, wherein the metal tube is a disposed around a conductive ring on one end, the conductive ring placing the metal tube in electrical contact with said one of said electrical conductors.

8. The high intensity discharge lamp of claim 1, wherein the electrically conductive element is at least one of (i) a metal tube, (ii) a portion of a metal tube, and (iii) a shaped metallic element, each of which is formed on said leg and electrically connecting one of said electrical conductors to said conductive layer.

9. The high intensity discharge lamp of claim 1, wherein the lamp is a voidless lamp and said legs are said electrical conductors, wherein the electrically conductive element is a conductive ceramic plug formed in a body of said central portion, the conductive ceramic plug providing an electrical connection from one of said electrical connectors to a conductive layer.

10. The high intensity discharge lamp of claim 1, wherein said conductive layer further comprises:
a first segment, in electrical contact with said electrically conductive element, and extending along one of said legs;
a second segment extending from said first segment to a curved portion of a plug side of said central portion;
a third segment extending from said second segment to a point on a surface of said central portion; and
a fourth segment extending from said point on a surface of said central portion along said surface of said central portion.

11. The high intensity discharge lamp of claim 10, wherein said fourth segment of said conductive layer extends along a circumference of said central portion.

12. The high intensity discharge lamp of claim 10, wherein said fourth segment of said conductive layer extends parallel to a central axis of said central portion.

13. The high intensity discharge lamp of claim 10, wherein a length of said third segment is selected to position the fourth segment near a tip of an electrode contained within said arc tube.

14. The high intensity discharge lamp of claim 13, wherein said length is selected to position the fourth segment within 0 mm-3 mm axial distance of the tip of said electrode.

15. The high intensity discharge lamp of claim 1, wherein each of said legs includes an elongated portion and a larger sized plug portion that is received in an opening at said end of said central portion.

16. The high intensity discharge lamp of claim 3, wherein said foil is electrically attached to said frame member.

17. The high intensity discharge lamp of claim 1, comprising one or more inert gas, and a dose of mercury and metal halides sealed in said discharge region.

18. The high intensity discharge lamp of claim 1, wherein said one of said legs has a first end at which one of said electrical conductors enters a recess in said one of said legs, wherein said electrically conductive element further comprises:
an electrically conductive sealing ring melted to form an electric connection between said one of said electrical conductors and an outer surface of said one of said legs on which said conductive layer is disposed.

19. The high intensity discharge lamp of claim 18, wherein said sealing ring is formed from a first non-conductive sealing ring and a second conductive sealing ring, the second conductive sealing ring melted on a top of said first non-conductive sealing ring.

20. A high intensity discharge lamp, comprising:
an electrically insulating arctube comprised of light transmissive material having a central portion and two legs each of which extends from said central portion, said central portion forming an interior discharge region;
electrical conductors each extending through one of said legs and being spaced apart from each other in said discharge region;
a sealed shroud comprised of light transmissive material enclosing said arc tube and electrical connection to said electrical conductors through said sealed shroud; and
a conductive layer net ignition aid comprising a conductive layer formed on said central portion and extending to an electrically conductive element on one of said legs.

21. The high intensity discharge lamp of claim 20, further comprising:
an electrically conductive frame member disposed in an interior of said shroud that is electrically connected to one of said electrical conductors by a foil, the foil having one end coupled to the electrically conductive frame member, and a second end encircling one of said legs of said arc tube at an end of said conductive layer.

22. The high intensity discharge lamp of claim 20, wherein the electrically conductive element is a metallic structure including at least one of (i) a coiled coil wire structure and (ii) a strip of a metallic mesh.

23. The high intensity discharge lamp of claim 20, wherein said conductive layer is formed of segments, the segments including at least a first segment connecting said electrically conductive element with a point on said central area of said arc tube.

24. The high intensity discharge lamp of claim 23, wherein said conductive layer further comprises:
at least a second element, encircling said central area of said arc tube at said point.

25. The high intensity discharge lamp of claim 23, wherein said point on said central area of said arc tube is near a tip of one of said electrical conductors in said discharge region.
